(19) United States
(12) Patent Application Publication
(10) Pub. No.: US 2023/0044154 A1
(43) Pub. Date: Feb. 9, 2023

(54) T-SCAVENGED OPPOSED PISTON ENGINE

(71) Applicant: Pinnacle Engines, Inc., San Carlos, CA (US)

(72) Inventor: Clayton NABER, San Mateo, CA (US)

(73) Assignee: Pinnacle Engines, Inc., San Carlos, CA (US)

(21) Appl. No.: 17/893,177

(22) Filed: Aug. 23, 2022

Related U.S. Application Data
(60) Provisional application No. 63/203,604, filed on Jul. 27, 2021.

(51) Int. Cl. F02B 33/30; F02B 75/28; F02B 25/08

(52) U.S. Cl. CPC F02B 33/30; F02B 25/08; F02B 75/282; F02B 2075/025

(57) ABSTRACT

A novel two-stroke opposed piston engine with sleeve valves and T-scavenging breathing is provided. The two-stroke opposed piston engine has a unique uni-flow scavenging breathing that can deliver higher power density than the traditional uniflow-scavenging two-stroke opposed piston engine. Furthermore, a method of operating a two-stroke opposed piston engine is provided. The novel opposed piston engine can be a hybrid engine with one or more electric machines.

### CROSS-REFERENCES TO RELATED APPLICATIONS

This application claims the benefit of U.S. Provisional Pat. Application No. 63/203,604, entitled “T-SCAVENGED OPPOSED PISTON ENGINE,” filed Jul. 27, 2021, which is incorporated herein by reference for all purposes.

### TECHNICAL FIELD

The present subject matter is in the field of internal combustion engines. More particularly, embodiments of the present subject matter relate to a two-stroke opposed piston engine.

### BACKGROUND

As one type of internal combustion engine, an opposed piston engine has two reciprocating pistons, one at each end of the cylinder. Opposed piston engines used to be widely adopted in the aviation industry and continue to be used today. Particularly when designed to support low-temperature combustion, opposed piston engines offer significantly higher fuel efficiency and cost benefits over other internal combustion engines. A two-stroke uniflow-scavenged working cycle is often chosen for opposed-piston engine designs in order to maintain a competitive power density (power output relative to the engine’s mass) in comparison to other designs, such as poppet-valve four stroke engines.

However, uniflow scavenged two-stroke engines have an inherent limitation in their power density due to the excessive thermal load imposed on the exhaust ports and piston crown nearest the exhaust port. This heating ultimately limits the specific power (power relative to cylinder capacity) that the engine can generate at sustained periods.

A hybrid engine combines an internal combustion engine with an electric motor. It not only offers fuel efficiency over traditional internal combustion engines but also substantially reduces pollutant emissions. In the case of an opposed-piston engine, hybrid engine further offers the opportunity to modify the thermodynamic working cycle of the engine.

### SUMMARY

The present subject matter pertains to a novel hybrid two-stroke opposed piston engine that has a sleeve valve and T-scavenging breathing. By combining one or more camshaft-controlled exhaust valves with classic two-stroke bore wall with inlet ports, the present opposed piston engine has unique T-scavenging breathing that can deliver higher power density than the traditional uniflow-scavenging opposed piston engine.

In addition, the one or more exhaust valves can be controlled by variable valve timing to optimize efficiency at every speed and load condition. Furthermore, with the camshaft-controlled one or more exhaust valves disposed around the mid-plane and the inlet ports disposed near Bottom Dead Center (BDC) of the bore, the symmetric heat-path of the present engine can solve the heat-caused bore distortion caused by the asymmetric design of the uniflow-scavenging engine. It can further avoid excessive heating of one piston over the other, thus increasing the specific output of the engine.

The present subject matter can be implemented in numerous ways, including as a method, system, device, or apparatus. Several embodiments of the present subject matter are discussed below.

According to some embodiments, the present subject matter discloses a two-stroke opposed piston engine, comprising a cylindrical chamber, a first piston, and a second piston slidably disposed in the cylindrical chamber, surfaces of the first piston and the second piston and walls of the cylindrical chamber defining an internal combustion volume. The engine has at least one exhaust valve disposed near the mid-plane of the cylindrical chamber, and each of a first intake port and a second intake port is disposed substantially near the Bottom Dead Center (BDC) of the bore.

According to some embodiments, the lift event of the exhaust valve, or valves, can be controlled by an exhaust camshaft or camshafts, whereas the intake ports are respectively controlled by the movement of the two opposed pistons.

During a T-scavenging process, fresh air can enter the internal combustion volume through the first intake port and the second intake port so that it expels the exhaust gas, from both directions, substantially toward the mid-plane of the cylindrical chamber to exit the internal combustion volume, via the at least one exhaust valve. According to some embodiments, during the T-scavenging processing, at least one of the first intake port and the second intake port's closure is delayed.

According to some embodiments, during a blowdown process before the scavenging process, the at least one exhaust valve is configured to be at least partially open to allow the exhaust gas exiting the internal combustion volume prior to the opening of the intake ports.

According to some embodiments, the present subject matter discloses a hybrid two-stroke opposed piston engine that further comprises an electric machine coupled to at least one of the first piston and the second piston, the electric machine is configured to control the movement of the at least one of the first piston and the second piston to achieve optimized engine efficiency. According to some embodiments, the electric machine is configured to be incorporated a crankshaft assembly associated with the first piston or the second piston.

Furthermore, the present subject matter discloses a method of operating a two-stroke opposed piston engine having a first piston and a second piston slidably disposed in the cylindrical chamber, comprising enabling combustion of a mixture of air and fuel in the cylindrical chamber, enabling, during a blowdown process, exhaust gas from the combustion to exit the cylindrical chamber through at least one exhaust valve controlled by an exhaust camshaft or camshafts, and enabling, during a scavenging process, fresh air to enter the cylindrical chamber through two conversely disposed intake ports, wherein the fresh air expels the remaining exhaust gas exiting through the exhaust valve or valves, from opposing directions, substantially toward a middle-plane of the cylindrical chamber. According to some embodiments, the two-stroke opposed piston engine is a hybrid engine with one or more electric machines.

Details of one or more implementations are set forth in the accompanying drawings and the description below. Other features, aspects, and potential advantages will be apparent from the description and drawings, and from the claims.

### DESCRIPTION OF DRAWINGS

The present subject matter is illustrated by way of example, and not by way of limitation, in the figures of the accompanying drawings and in which:

FIG. 1 is a traditional two-stroke opposed piston engine with a uni-flow scavenging design;

FIG. 2 is a four-stroke opposed piston engine according to some embodiments;

FIG. 3 illustrates a T-scavenging process of the hybrid two-stroke T-scavenged opposed piston engine according to some embodiments;

FIG. 4 illustrates a compression process of the hybrid two-stroke T- scavenged opposed piston engine according to some embodiments;

FIG. 5 illustrates a combustion process of the hybrid two-stroke T-scavenged opposed piston engine according to some embodiments;

FIG. 6 illustrates an expansion process of the hybrid two-stroke T- scavenged opposed piston engine according to some embodiments;

FIG. 7 illustrates a blowdown process of the hybrid two-stroke T-scavenged opposed piston engine according to some embodiments; and

FIG. 8 is an example flow diagram illustrating one embodiment of the present subject matter.

### DETAILED DESCRIPTION

Various embodiments of the present technology are discussed in detail below. While specific implementations are discussed, it should be understood that this is done for illustration purposes only. A person skilled in the relevant art will recognize that other components and configurations may be used without departing from the spirit and scope of the present technology.

In the following description, for purposes of explanation, numerous specific details are set forth in order to provide a thorough understanding of the present subject matter. It will be apparent, however, to one skilled in the art that the present subject matter may be practiced without some of these specific details. In addition, the following description provides examples, and the accompanying drawings show various examples for the purposes of illustration. Moreover, these examples should not be construed in a limiting sense as they are merely intended to provide examples of embodiments of the subject matter rather than to provide an exhaustive list of all possible implementations. In other instances, well-known structures and devices are shown in block diagram form in order to avoid obscuring the details of the disclosed features of various described embodiments.

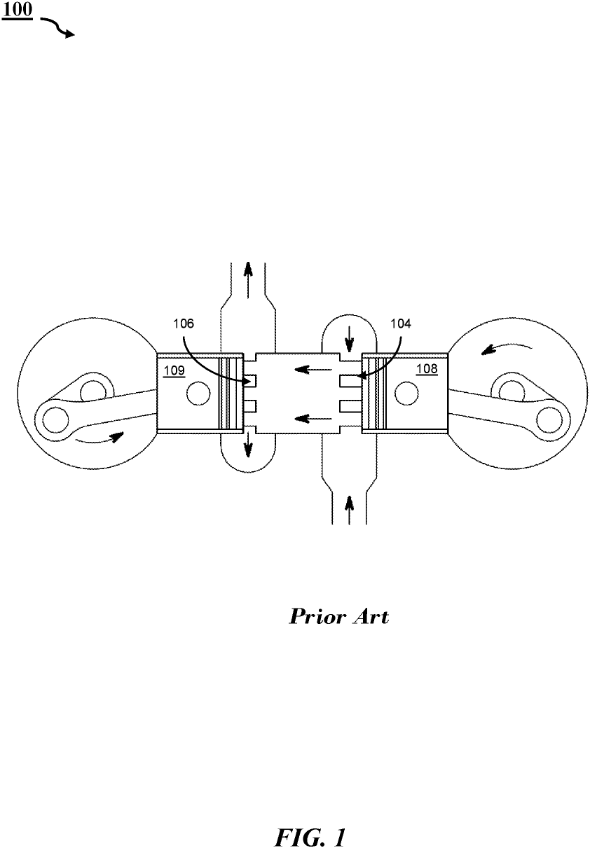

FIG. 1 is a traditional two-stroke opposed piston engine 100 with a uni-flow scavenging design. Scavenging is the process of replacing the exhaust gas in an engine cylinder with the fresh air and/or fuel mixture for the next combustion cycle. If scavenging is incomplete, the remaining exhaust gases can cause improper combustion for the next cycle, or if scavenging is excessive and a large amount of fresh air bypasses directly to the exhaust, this leads to reduced power output from consumed “pumping work”. The present state-of-the-art two-stroke opposed piston engines are typically uniflow scavenged, in which the fresh intake charge and exhaust gases flow in the same direction.

As shown in FIG. 1, two-stroke opposed piston engine 100 has an intake piston 108, the movement of which can open and close one or more intake ports 104 that are embedded in the sides of the bore wall. Two-stroke opposed piston engine 100 also has an exhaust piston 109, the movement of which can open and close the one or more exhaust port 106 that is similarly embedded in bore wall. During an intake stroke, intake piston 108 can retract and expose intake port 104 to allow fresh air and/or fuel to enter the cylinder; during an exhaust stroke, exhaust piston 109 can retract to expose exhaust port 106 so that the exhaust gas can exit the cylinder. Thus, the direction of the airflow is one-direction, or flow from the intake port to the exhaust port.

As the high-velocity exhaust gas constantly escapes from one side (the exhaust-port side) of the engine bore, the excessive heat in the exhaust gas can overheat areas around the exhaust port. It can cause undesired distortion of the exhaust piston, the exhaust cylinder liner and the bore.

Specifically, the grid of port wall material that bridges the exhaust port opening in the cylinder wall can get heated substantially by the escaping hot exhaust gas, which causes the cylinder liner material to thermally expand, leading to bore wall shape distortions. Such distortions can cause difficulty in sealing the piston ring because they are localized, i.e., not uniformly distributed throughout the engine liner. As a result, the engine bore could be deformed into a non-round or irregular shape, which is difficult for piston rings to seal.

As a result, the traditional two-stroke opposed piston engines are restricted by exhaust piston durability due to the thermal load imposed by the asymmetric uniflow-scavenging porting arrangement.

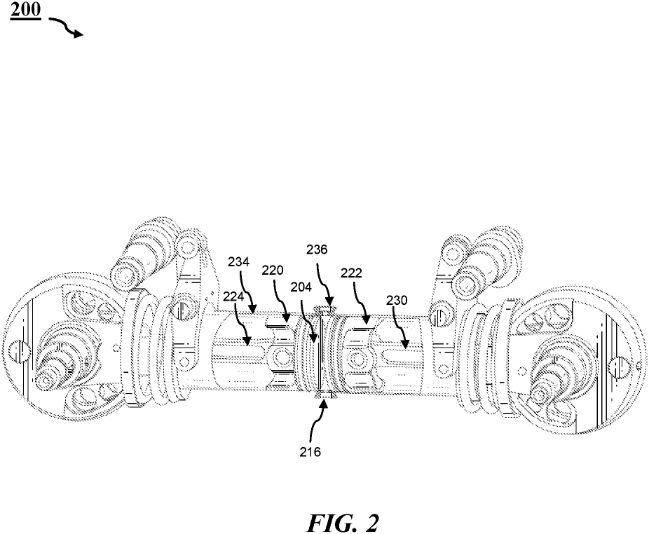

FIG. 2 is a hybrid four-stroke opposed piston engine 200 according to some embodiments. Hybrid opposed piston engine 200 includes two pistons that share a common cylinder and form a combustion volume defined by the pistons and the walls of the cylinder.

As shown in FIG. 2, opposed piston engine 200 is configured such that a left piston 220 and a right piston 222 reciprocate within a cylinder 204 along a centerline of the cylinder 204. The left piston 220 is connected to a left connecting rod 224, which in turn connects to a left crankshaft. The right piston 222 is connected to a right connecting rod 230, which in turn connects to a right crankshaft. The left piston 220 reciprocates within cylinder 204, and is slidably movable to the left and right along the cylinder wall 234. The right piston 222 also reciprocates within cylinder 204, and is slidably movable to the left and right along the cylinder wall 234.

Opposed piston engine 200 also has a sleeve valve that can be slidably movable to the left and right (from the FIG. 2 perspective) to control exhaust port 216, such as relative to a fuel injector 236. The sleeve valve is also configured to control exhaust port 216 disposed near Top Dead Center (TDC) of the engine. The left piston 220 and right piston 222 are disposed in the cylinder 204 as they would be at TDC, with the combustion volume, which is defined by the cylinder wall 234 and the piston heads of the left piston 220 and right piston 222, at its smallest. The engine can be configured such that the ignition timing occurs either at, before, or after the minimum combustion volume.

Opposed piston engine 200 further comprises one or more electric machine (not shown) coupled to one or both of the pistons, e.g., left piston 220 and/or rig piston 222. The electric machine can be a motor/generator. According to some embodiments, the electric machine is configured to control the movement of the at least one of the pistons to achieve optimized engine efficiency, and facilitates integrating the engine into a hybrid electric powertrain. According to some embodiments, the electric machine can be incorporated into at least one crankshaft assembly associated with one of the pistons. The incorporated electric machine and crankshaft design can replace or reduce the mechanical synchronization drive caused by gears, belt or chain, to reduce noise, friction, and energy loss. Furthermore, the electric machine can deliver instantaneous, continuously variable crank-to-crank phasing, providing increased engine efficiency.

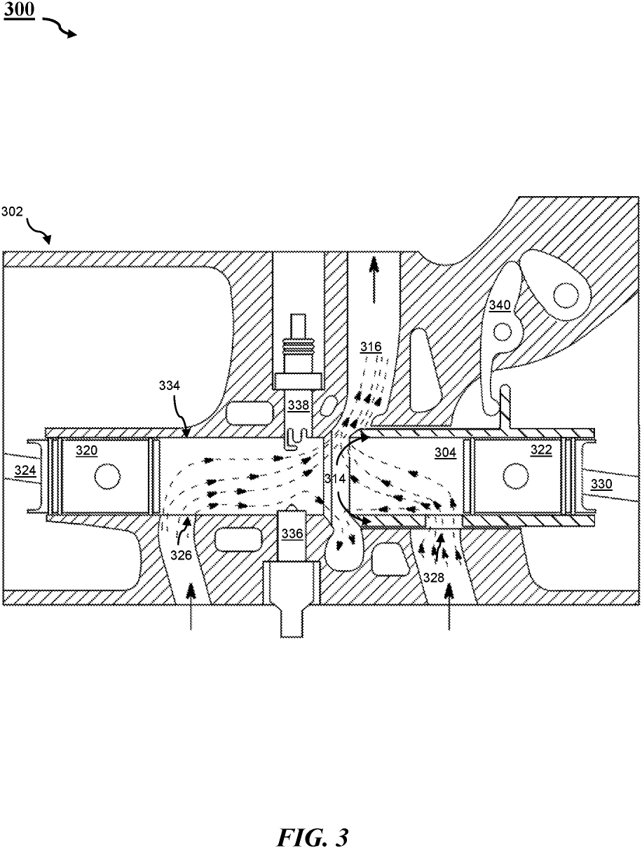

FIG. 3 illustrates a T-scavenging process 300 of a two-stroke T-scavenged opposed piston engine 302 (hereinafter “piston engine 302”), according to some embodiments. Piston engine 302 can comprise first piston 320 and second piston 322 slidably disposed within cylinder wall 334, wherein surfaces of first piston 320 and second piston 322 and walls of the cylindrical chamber 334 can define an internal combustion volume. First piston 320 can be connected to a first crankshaft assembly through first connecting rod 324. Second piston 322 can be connected to a second crankshaft assembly through second connecting rod 330. In addition, piston engine 302 can comprise fuel injector 336 and spark plug 338.

A scavenging process happens at the end of the blowdown phase of an engine cycle. As shown in FIG. 3, first piston 320 and second piston 322 have reached near BDC of the bore by the combustion/expansion. First intake port 326 and second intake port 328 are embedded ports in the sides of the bore walls. According to some embodiments, first intake port 326 can be controlled by movement of first piston 320 relative to a first port/bore of cylindrical chamber 304, whereas second intake port 328 can be controlled by movement of second piston 322 relative to a second port/bore of cylindrical chamber 304. The opening events of the two intake ports can be simultaneous or individual, e.g., one intake port can advance its opening and/or delay its closure.

Furthermore, at least one exhaust valve 316 is disposed substantially near the mid-plane of the cylindrical chamber. Each of first intake port 326 and second intake port 328 is disposed substantially near the BDC of cylindrical chamber 304. The geometry of the intake ports and the at least one exhaust valve can form a substantial T-shaped air pathway.

To create a T-scavenging airflow, first intake port 326 and second intake port 328 can be fully open/exposed to allow fresh air flow into cylindrical chamber 304. At the same time, exhaust camshaft 340 can control sleeve valve 314 to fully open exhaust valve 316, which enables exhaust gas to exit cylindrical chamber 304. A “T-scavenging” process is created because the fresh air pressure can expel exhaust gas from the previous cycle to leave the cylindrical chamber.

Specifically, as shown in the airflow direction in FIG. 3, during the T-scavenging, fresh air can enter cylindrical chamber 304 through first take port 326 and second intake port 328 so that it pushes the exhaust gas, from both directions, substantially toward the mid-plane of cylindrical chamber 304 to exit the internal combustion volume, via exhaust valve 316. Such a T-shaped scavenging process can not only provide the advantages of fully replacing the exhaust gas with the fresh air and/or fuel mixture of uni-flow scavenging, but also offer several advantages over the traditional design, as further explained below.

First, due to its symmetric heat-path (the valve opens circumferentially around the full perimeter of the bore rather than through ports asymmetrically arranged on the bore wall), the T-scavenging process can solve the bore-distortion issue in the uniflow scavenging engine, which is caused by the asymmetrical excessive heating. It can further eliminate excessive heating of one piston over the other by placing the exhaust opening at the mid-plane of the engine near the TDC piston position, which avoids convective heating of either piston crown by moving the high velocity, high temperature gas stream away from the pistons situated at BDC during blowdown, increasing the specific output of the engine that can be sustained before the practical temperature limit of the piston is reached. Reducing the piston crown temperature also improves volumetric efficiency, reducing the amount of boost pressure required to achieve a given engine power output level, further improving power density and efficiency.

Second, the camshaft-controlled at least one exhaust valve of the present subject matter can provide the benefits of variable valve timing. Variable valve timing (VVT) is the mechanism to dynamically altering the timing of a valve lift event for improved engine performance, fuel economy or emissions. Various methods and apparatus can be used to implement the VVT to optimize the performance. For example, exhaust camshaft 340 can adopt a variator in a cam phasing, or an oscillating cam, or cam switching, etc. A person skilled in the relevant art will recognize that other VVT mechanisms may be used without departing from the present disclosure.

Furthermore, according to some embodiments, during the scavenging process, at least one of first intake port 326 and second intake port 328’s closure is delayed. Such delayed closure can manipulate the breathing process so that it can minimize pumping loss, as the late intake port closure can reduce the amount of exhaust air trapped in the cylindrical chamber. Such late closure can be achieved by, for example, holding one of first piston 320 or second piston 322, static for a predetermined amount of time. For example, the delayed closure can be implemented by modulating movement of at least one of the first crankshaft assembly and the second crankshaft assembly.

According to some embodiments, piston engine 302 can further comprise one or more electric machines configured to control the movement of at least one of first piston 320 and second piston 322 to achieve optimized engine efficiency. According to some embodiments, the one or more electric machines can be incorporated into the crankshaft assembly associated with one of first piston 320 and second piston 322. The incorporated electric machine and crankshaft design can replace or reduce the mechanical synchronization drive caused by gears, belt or chain, to reduce noise, friction, and energy loss. Furthermore, the electric machine can deliver instantaneous, continuously variable crank-to-crank phasing, providing an increased engine efficiency.

As such, by combining a flexibly-controlled at least one exhaust valve with classic intake ports, piston engine 302 can enable unique T-scavenging breathing that can deliver higher power density than the traditional uniflow-scavenging two-stroke opposed piston engine. Furthermore, among its numerous advantages, the symmetric T-shaped scavenging process can solve the uneven heating and distortion of the traditional uniflow scavenged cylinder bore.

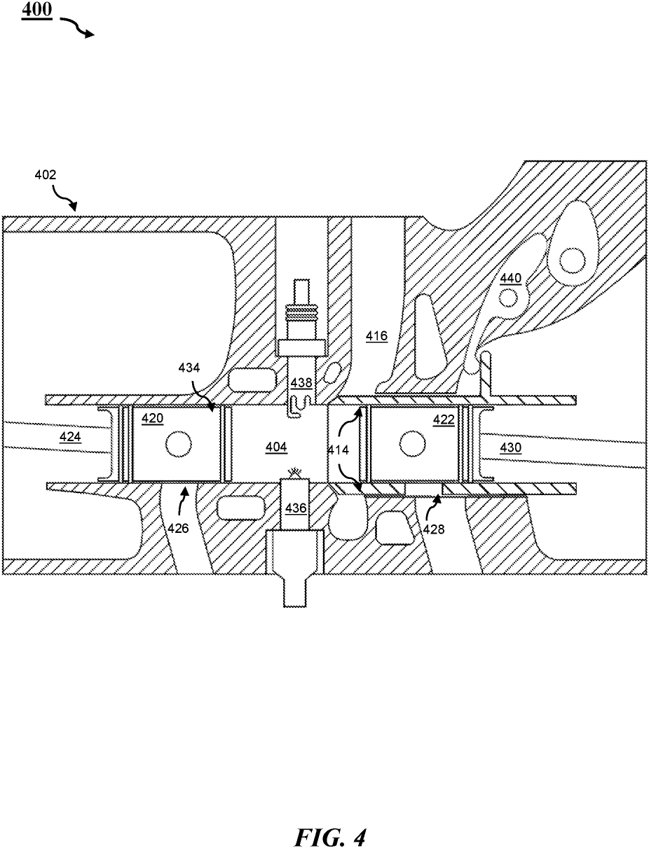

FIG. 4 illustrates a compression process 400 of a two-stroke T-scavenged opposed piston engine 402 (hereinafter “piston engine 402”), according to some embodiments. Piston engine 402 can comprise first piston 420 and second piston 422 slidably disposed within cylinder wall 434, wherein surfaces of first piston 420 and second piston 422 and walls of cylindrical chamber 434 defining an internal combustion volume. First piston 420 can be connected to a first crankshaft assembly through first connecting rod 424. Second piston 422 can be connected to a second crankshaft assembly through second connecting rod 430. In addition, piston engine 302 can comprise fuel injector 436 and spark plug 438.

A compression process happens at the end of the scavenging process and marks the beginning of a new combustion cycle. As shown in FIG. 4, first piston 420 and second piston 422 have moved past first intake port 426 and second intake port 428 to compress fresh air in cylindrical chamber 404. As a result, both intake ports have been closed. Furthermore, exhaust camshaft 440 can control sleeve valve 414 to fully close at least one exhaust valve 416. Accordingly, cylindrical chamber 404 is a fully enclosed space for the next combustion process.

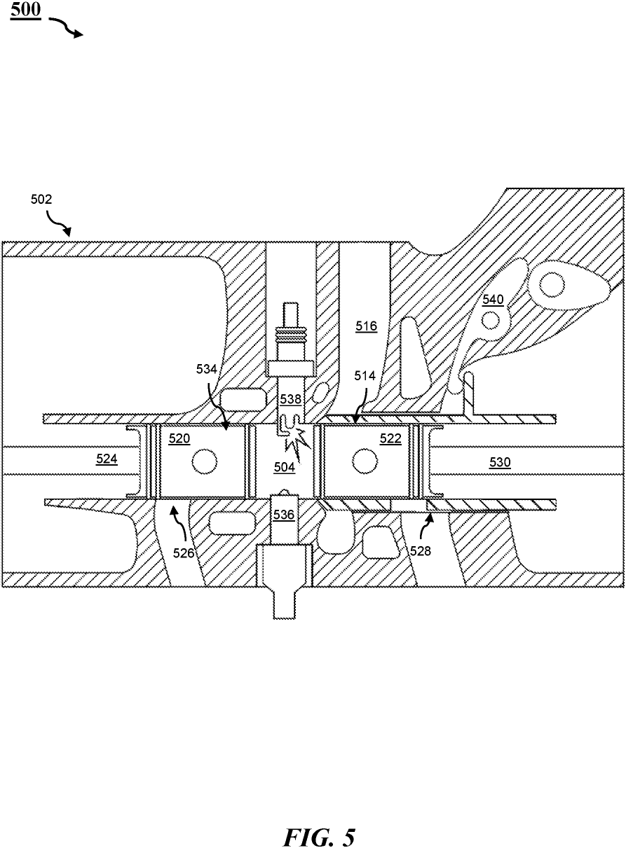

FIG. 5 illustrates a combustion process 500 of a two-stroke T-scavenged opposed piston engine 502 (hereinafter “piston engine 502”), according to some embodiments. Piston engine 502 can comprise first piston 520 and second piston 522 slidably disposed within cylinder wall 534, wherein surfaces of first piston 520 and second piston 522 and walls of cylindrical chamber 534 defining an internal combustion volume. First piston 520 can be connected to a first crankshaft assembly through first connecting rod 524. Second piston 522 can be connected to a second crankshaft assembly through second connecting rod 530.

During the combustion process, first piston 520 and second piston 522 have almost reached TDC or passed TDC. Both first intake port 526 and second intake port 528 are completely closed. Exhaust camshaft 540 can control sleeve valve 514 to fully close at leaste one exhaust valve 516.

During or prior to the combustion process, fuel injector 536 is configured to inject or spray fuel into cylindrical chamber 504. The injected fuel is mixed with the compressed fresh air, which is ignited by spark plug 538. Following the ignition, combustion of the mixed air and fuel within cylindrical chamber 504 can generate usable thermodynamic movement of first piston 520 and second piston 522, which constitutes the expansion process of the cycle.

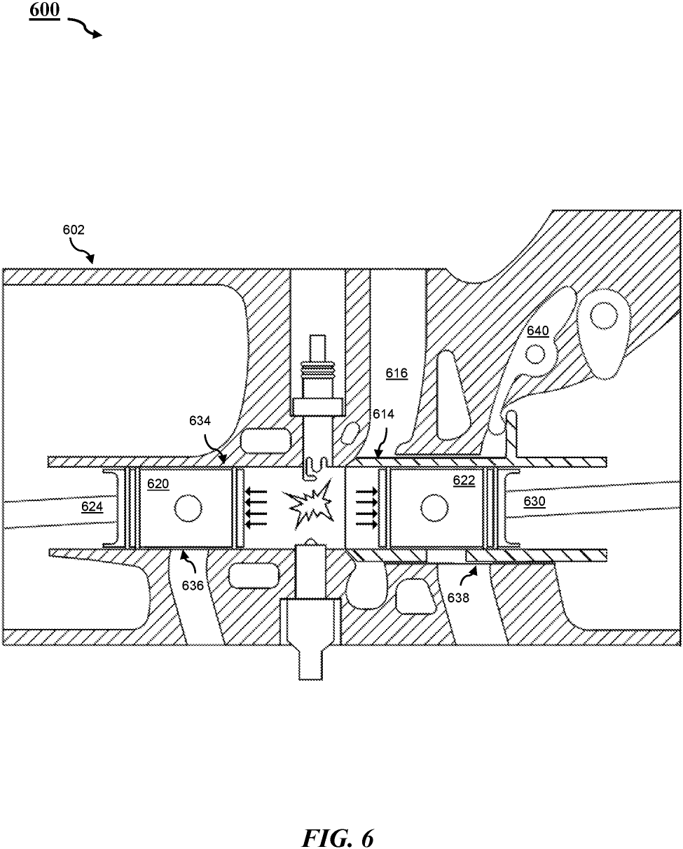

FIG. 6 illustrates an expansion process 600 of a two-stroke T-scavenged opposed piston engine 602 (hereinafter “piston engine 602”), according to some embodiments. First piston 620 and second piston 622 slidably disposed within cylinder wall 634, wherein surfaces of first piston 620 and second piston 622 and walls of cylindrical chamber 634 defining an internal combustion volume. First piston 620 can be connected to a first crankshaft assembly through first connecting rod 624. Second piston 622 can be connected to a second crankshaft assembly through second connecting rod 630.

During the expansion process, first piston 620 and second piston 622 have retreated from TDC and are moving toward BDC of the engine. As shown in FIG. 6, both pistons still have completely closed first intake port 626 and second intake port 628. Furthermore, exhaust camshaft 640 can control sleeve valve 614 to fully close at least one exhaust valve 616. According to some embodiments, one or more electric machines can be incorporated into the first or second crankshaft to control the movement of the pistons.

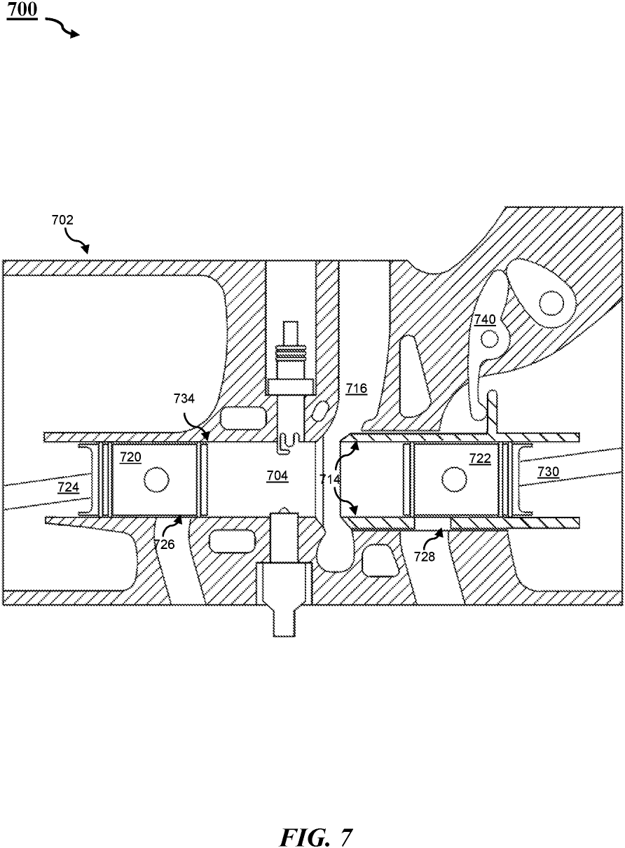

FIG. 7 illustrates a blowdown process 700 of a two-stroke T-scavenged opposed piston engine 702 (hereinafter “piston engine 702”), according to some embodiments. A blowdown process is a transitional state between the expansion process and the scavenging process, during which the exhaust gas is expelled from the chamber. The blowdown process can transition into the T-scavenging process. Thermodynamic efficiency of the engine can be maximized by optimizing the opening timing of the at least one exhaust valve via variable valve timing..

As shown in FIG. 7, first piston 720 and second piston 722 can be slidably disposed within cylinder wall 734, wherein first piston 720 can be coupled to a first crankshaft assembly through first connecting rod 724, and second piston 722 can be coupled to a second crankshaft assembly through second connecting rod 730. During the blowdown process, at least one exhaust valve 716 can be partially or fully open so that exhaust gas can exit cylindrical chamber 704 before first piston 720 and second piston 722 traveling across first intake port 726 and second intake port 728.

Shortly following the opening of the at least one exhaust valve 716, the expansion of the combustion can push first piston 720 and second piston 722 to uncover the intake ports 726 and 726, which are embedded in the sides of the bore walls. This allows fresh air to enter the combustion chamber and marks the initiation of the scavenging process, as illustrated in FIG. 3.

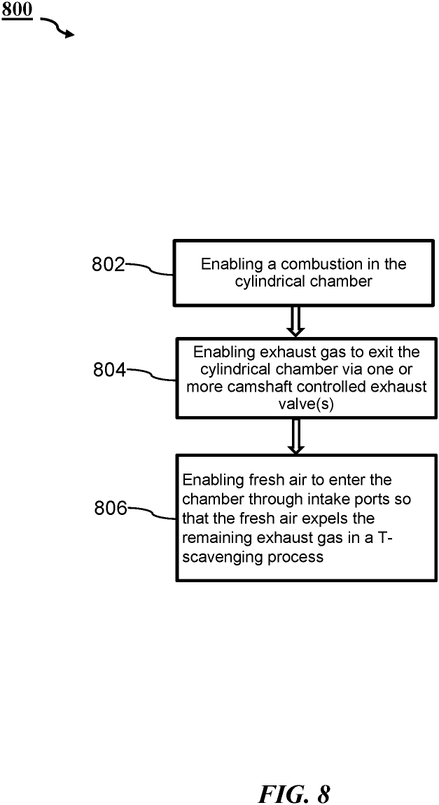

FIG. 8 is an example flow diagram illustrating one embodiment of the present subject matter. The present subject matter pertains to a method of operating a hybrid two-stroke opposed piston engine having a T-scavenging airpath. The engine can comprise a first piston and a second piston slidably disposed within a cylindrical chamber, wherein surfaces of the pistons and walls of the chamber defining an internal combustion volume.

The hybrid two-stroke opposed piston engine has one or more exhaust valves that is/are disposed substantially near the mid-plane of the cylinder chamber. The lift events of the exhaust valve or valves can be controlled by an exhaust camshaft or a plurality of camshafts with variable valve timing. The engine's intake ports are embedded in the cylinder bores being disposed symmetrically near the BDC of the cylinder chamber. The opening events of the intake ports can be respectively controlled by the movement of the first piston and the second piston relative to the first and second bore.

At step 802, the method comprises enabling the combustion of air and fuel in the cylindrical chamber in a combustion process of a two-stroke opposed piston engine. During the combustion process, both intake ports and the exhaust valve or valves have been closed. A fuel injector can inject or spray fuel into the cylinder chamber, which is immediately mixed with the compressed fresh air. The combustion of the mixed air/fuel can be triggered by the ignition of a spark plug. Following the ignition, the combustion can propel the movement of the first piston and the second piston for power output.

At step 804, the method comprises enabling exhaust gas from the combustion to exit the cylindrical chamber through the exhaust valve or valves during a blowdown process. A blowdown process is a transitional state between the expansion process and the scavenging process, which can be implemented by the early opening of the exhaust valve or valves prior to the opening any one of the intake ports. During the blowdown process, the exhaust camshaft or camshafts can partially or fully open the exhaust valve or valves before the traveling pistons open any of the intake ports. The early opening of the exhaust valve or valves can enable the exhaust gas to escape from the combustion chamber due to the high internal pressure.

At step 806, the method comprises enabling fresh air to enter the cylindrical chamber through the two conversely disposed intake ports, wherein the fresh air expels the remaining exhaust gas escaping through the exhaust valve or valves, from opposing directions, substantially toward a middle-plane of the cylinder chamber in a T-scavenging process.

Specifically, to create a T-scavenging airflow, the first intake port and the second intake port can be fully open/exposed to allow fresh air flow into the cylindrical chamber. At the same time, the exhaust camshaft or camshafts can control the sleeve valve or valves to fully open the exhaust valve or valves, which allows exhaust gas to leave the cylindrical chamber from the pressure of the fresh air.

Besides providing the advantages of the uniflow scavenging, the T-shaped scavenging process can offer several advantages over the issue in the uniflow scavenging engine. It can further eliminate excessive heating of one piston over the other and increase the specific output of the engine.

Furthermore, the camshaft-controlled exhaust valve or valves of the present subject matter can provide the benefits of variable valve timing over the non-variable exhaust port in the uniflow scavenging engine. VVT is the mechanism to dynamically altering the timing of a valve lift event for improved engine performance, fuel economy or emissions. Various traditional design. First, due to its symmetric heat-path, the T-scavenging process can solve the bore-distortion methods and apparatus can be used to implement the VVT to optimize the performance. For example, the exhaust camshaft can adopt a variator in a cam phasing, or an oscillating cam, or cam switching, etc. On the two-stroke opposed-piston engine, varying the exhaust valve opening timing can be used to maximize the useful work extracted in the expansion stroke of the engine in response to the power level the engine is being operated at. When operating at low power output, the amount of fuel and air mass that enters the cylinder is small in comparison to the amount of fuel and air mass that enters when the engine is being operated at or near its maximum power output. When the engine is operating at a relatively low power output, the exhaust valve opening timing that achieves maximum net thermodynamic efficiency is different than the exhaust valve opening timing that results in maximum efficiency when the engine is being operated at or near its maximum power level. VVT allows the opposed-piston, two-stroke, sleeve valve to have higher efficiency at part load than two-stroke, opposed-piston engines with fixed exhaust ports such as the uniflow-scavenged design.

According to some embodiments, during the T-scavenging process, at least one of the intake ports’ closure is delayed. Such delayed closure can manipulate the breathing process so that it can minimize pumping loss. Such late closure can be achieved by, for example, holding one of the first piston and second piston static for a predetermined amount of time. It can be achieved by modulating the movement of the associated crankshaft assembly. According to some embodiments, one or both pistons can be held static for a predetermined amount of time to delay either intake ports' closure.

According to some embodiments, a hybrid two-stroke opposed piston engine can further comprise one or more electric machines configured to control the movement of at least one of the two pistons to achieve optimized engine efficiency. According to some embodiments, the one or more electric machines can be incorporated into the crankshaft assembly to replace or reduce the mechanical synchronization drive caused by gears, belt or chain, to reduce noise, friction, and energy loss. Furthermore, the electric machine can deliver instantaneous, continuously variable crank-to-crank phasing, providing an increased engine efficiency.

A number of implementations have been described. Nevertheless, it will be understood that various modifications may be made. For example, other steps may be provided, or steps may be eliminated from the described flows, and other components may be added to, or removed from, the described systems. Accordingly, other implementations are within the scope of the following claims.

Although a variety of examples and other information was used to explain aspects within the scope of the appended claims, no limitation of the claims should be implied based on particular features or arrangements in such examples, as one of ordinary skill would be able to use these examples to derive a wide variety of implementations. The described features and steps are disclosed as examples of components of systems and methods within the scope of the appended claims.

1. A two-stroke opposed piston engine, comprising:
a cylindrical chamber;
a first piston and a second piston slidably disposed in the cylindrical chamber, surfaces of the first piston and the second piston and walls of the cylindrical chamber defining an internal combustion volume;
a first intake port and a second intake port in the cylindrical chamber to allow fresh air flow into the cylindrical chamber during a scavenging process; and
at least one exhaust valve controlled by an exhaust camshaft, the exhaust valve is configured to allow exhaust gas to exit the internal combustion volume during the scavenging process.

2. The two-stroke opposed piston engine of claim 1, wherein, during a blowdown process before the scavenging process, the at least one exhaust valve is configured to be at least partially open to allow the exhaust gas existing the internal combustion volume.

3. The two-stroke opposed piston engine of claim 1, wherein, during the scavenging process, fresh air enters the internal combustion volume through the first intake port and the second intake port so that it expels the exhaust gas, from both directions, substantially toward a mid-plane of the cylindrical chamber to exit the internal combustion volume, via at least one exhaust valve.

4. The two-stroke opposed piston engine of claim 1, wherein the first intake port operated by the first piston and a first bore of the cylindrical chamber; and wherein the second intake port is operated by the second piston and a second bore of the cylindrical chamber.

5. The two-stroke opposed piston engine of claim 1, wherein, during the scavenging processing, wherein at least one of the first intake port and the second intake port's closure is delayed.

6. The two-stroke opposed piston engine of claim 1, further comprising:
a fuel injector configured to inject fuel in the cylindrical chamber during a compression process, and
an ignition spark configured to initiate combustion during a combustion process.

7. The two-stroke opposed piston engine of claim 1, further comprising:
at least one electric machine coupled to at least one of the first piston and the second piston, the at least one electric machine is configured to control movement of the at least one of the first piston and the second piston to achieve optimized engine efficiency.

8. The two-stroke opposed piston engine of claim 7, wherein the at least one electric machine is configured to be incorporated at least one crankshaft assembly associated with at least one of the first piston and the second piston.

9. The two-stroke opposed piston engine of claim 1, wherein the at least one exhaust valve is disposed substantially near a mid-plane of the cylindrical chamber.

10. The two-stroke opposed piston engine of claim 1, wherein each of the first intake port and the second intake port is disposed substantially near the bottom dead center of the cylindrical chamber.

11. A two-stroke opposed piston engine, comprising:
a cylindrical chamber;
a first piston and a second piston slidably disposed in the cylindrical chamber, surfaces of the first piston and the second piston and walls of the cylindrical chamber defining an internal combustion volume;
at least one intake port in the cylindrical chamber to allow fresh air flow into the cylindrical chamber during a scavenging process; and
at least one exhaust valve controlled by an exhaust camshaft, the exhaust valve is configured to allow exhaust gas to exit the internal combustion volume during the scavenging process.

12. The two-stroke opposed piston engine of claim 11, wherein the two-stroke opposed piston engine is a hybrid engine that comprises at least one electric machine.

13. The two-stroke opposed piston engine of claim 11, wherein, during a blowdown process before the scavenging process, the at least one exhaust valve is configured to be at least partially open to allow the exhaust gas to exit the internal combustion volume.

14. The two-stroke opposed piston engine of claim 11, wherein, during the scavenging process, fresh air enters the internal combustion volume through the first intake port and the second intake port so that it expels the exhaust gas, from both directions, substantially toward the mid-plane of the cylindrical chamber to exit the internal combustion volume, via the at least one exhaust valve.

15. A method of operating a two-stroke opposed piston engine having a first piston and a second piston slidably disposed in a cylindrical chamber, comprising:
enabling combustion of a mixture of air and fuel in the cylindrical chamber;
enabling, during a blowdown process, exhaust gas from the combustion to exit the cylindrical chamber through at least one exhaust valve controlled by an exhaust camshaft; and
enabling, during a scavenging process, fresh air to enter the cylindrical chamber through two conversely disposed intake ports, wherein the fresh air expels remaining exhaust gas existing through the at least one exhaust valve, from opposing directions, substantially toward a middle-plane of the cylindrical chamber.

16. The two-stroke opposed piston engine of claim 15, wherein, during the scavenging processing, wherein at least one of the two conversely disposed ports' closure is delayed.

17. The two-stroke opposed piston engine of claim 15, wherein the at least one exhaust valve is disposed substantially near the mid-plane of the cylindrical chamber.

18. The two-stroke opposed piston engine of claim 15, wherein each of the two conversely disposed ports is disposed substantially near a bottom dead center of the cylindrical chamber.

19. The two-stroke opposed piston engine of claim 15, wherein each of the two conversely disposed ports is operated by a sliding sleeve valve circling the cylindrical chamber.

20. (canceled)
